(19) United States
(12) Patent Application Publication
(10) Pub. No.: US 2005/0179619 A1
(43) Pub. Date: Aug. 18, 2005

(54) Electro-optical display device

(76) Inventors: Hugo Johan Cornelissen, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/511,805

(22) PCT Filed: Mar. 20, 2003
(86) PCT No.: PCT/IB03/01101

(30) Foreign Application Priority Data
Apr. 22, 2002 (EP) 02076558.2

(51) Int. Cl. G09G 3/06

(52) U.S. Cl. 345/44

(57) ABSTRACT

The electro-optical display device has a translucent front wall (12) and at least one pixel (10) with an electro-optical medium, a scattering medium (14) and a switching electrode (6) associated with the front wall (12), and drive means via which the pixel (10) can be brought to different optical states. According to the invention, the pixel (10) comprises a low-refractive index C material (21) with a refractive index nt in the range from 1.0≦1.4.4. Preferably, the low-refractive index material (21) is provided between the switching electrode (6) and the electro-optical medium. Preferably, the electro-optical medium is an electro-phoretic medium or an electro-chromic medium. The electro-optical display device combines a high brightness with a wide viewing angle.

The invention relates to an electro-optical display device comprising a translucent front wall and at least one pixel with an electro-optical medium, a scattering medium and a switching electrode associated with the front wall, and drive means via which the pixel can be brought to different optical states.

An example of an electro-optical display device is an electro-phoretic display device. Electro-phoretic display devices are based on the motion of charged, usually colored particles under the influence of an electric field between two extreme states having a different transmissivity or reflectivity. With these display devices, dark (colored) characters can be imaged on a light (colored) background, and vice versa. Electro-phoretic display devices are notably used in display devices taking over the function of paper are often referred to as “electronic paper” or “paper white” applications (electronic newspapers, electronic diaries).

Use in the claims or description of this invention of the wording “switching electrode” does not exclude that the electrode is, if desired, divided into a plurality of sub-electrodes which are supplied with one and the same voltage either externally or via switching elements.

In known electro-phoretic display devices, the electro-phoretic medium is provided between two switching electrodes, one of which is associated with the front wall while the other, normally, is associated with the rear wall. In operation, said switching electrodes are supplied with drive voltages, thereby bringing the pixel to two (extreme) optical states. One of the switching electrodes is realized, for example, as two mutually interconnected narrow conducting strips on the front wall of a pixel or display element. At a positive voltage across this switching electrode with respect to a bottom electrode covering the entire bottom surface of the display element, charged particles (for example, negatively charged) move to the potential plane which is defined by the two interconnected narrow conducting strips. The (negatively) charged particles spread across the front face of the pixel which assumes the color of the charged particles. At a negative voltage across the switching electrode with respect to the bottom electrode, the (negatively) charged particles spread across the rear wall of the pixel, the pixel assuming the color of the liquid.

Electro-phoretic display devices provide a viewing angle which is practically as wide as that of normal paper. This wide viewing angle is achieved by obtaining contrast by looking either at scattering (white) or absorbing (black) particles or at dark absorbing liquids (ink) with white scattering particles. In all cases, the incident light (either directional or diffuse) will be scattered in all directions by the particles. Whilst this results in an excellent viewing angle, a drawback is that this also results in a loss in brightness.

It is an object of the invention to eliminate the above disadvantage wholly or partly. According to the invention, an electro-optical display device of the kind mentioned in the opening paragraph is for this purpose characterized in that the pixel comprises a low-refractive index material with a refractive index nₗᵢ in the range from 1.0≦nₗᵢ≦1.6.

By introducing a low-refractive index material more light can be coupled out of the pixel, thereby increasing the brightness of the electro-optical display device. The invention is based on the recognition that light scattered at an angle higher than the limit angle for total internal reflection can not be coupled out of the pixel. By introducing a low-refractive index material the limit angle is increased enabling more light to be issued from the pixel.

Light which is incident on the pixel is redistributed by diffuse scattering in the known electro-optical display device can not escape from the front wall if the angle with the normal on the surface of the front wall exceeds the limit angle, θₗₐ. If the incoming light flux has a light flux Iᵢₙ, and the light that is reflected has a light flux Iₒᵤₜ, the relation between the incident light and the light that is coupled out of the pixel is, in first order approximation, given by:

$${I}_{out} \leq \frac{{I}_{in} ( 1 - cos ( 2 {θ}_{la} ) )}{2}$$

In the above formula, reflection in the pixel is assumed to be Lambertian. The ≦-sign in the equation has been introduced to indicate that additional Fresnel losses have been neglected. In Table I the reflected flux Iₒᵤₜ under normal conditions has been calculated for various values of the refractive index of the front wall.

TABLE I
Reflected flux for various values of the refractive index of the front wall.

| Refractive index n | Limit angle | Reflected flux |
|---|---|---|
| of front wall | θ₁ₐ | Iₒᵤₜ |
| 1.0 | 90.0° | 1.00 Iᵢₙ |
| 1.1 | 65.4° | 0.83 Iᵢₙ |
| 1.2 | 56.4° | 0.69 Iᵢₙ |
| 1.3 | 50.3° | 0.59 Iᵢₙ |
| 1.4 | 45.6° | 0.51 Iᵢₙ |
| 1.5 | 41.8° | 0.44 Iᵢₙ |
| 1.6 | 38.7° | 0.39 Iᵢₙ |

For a front wall made of glass or Poly(EthyleneTerephthalate) (PET) n≈1.5 and only 0.44×Iᵢₙ of the incident light is reflected. For a front wall made of PolyCarbonate n≈1.6 only 0.39×Iᵢₙ of the incident light is reflected.

By introducing a low-refractive index material more light can be coupled out of the pixel. Preferably, the refractive index of the low-refractive index material is nₗᵢ≦1.4.

A preferred embodiment of the electro-optical display device according to the invention is characterized in that the low-refractive index material is selected from the group formed by a fluor-polymer, a low-dielectric inorganic film and a low-dielectric nano-porous film. For fluor-polymers the refractive index is approximately 1.3. According to Table I the reflected flux for n≈1.3 increases to 0.59×Iᵢₙ, a gain of a factor of 0.59/0.44=1.34 with respect to the known electro-optical display devices. Low-dielectric films are for instance found in fluorides such as LiF, which has n≈1.39 or MgF₂ which has n≈1.38. Also fluosilicates are known to have a low index of refraction, e.g. MgSiF₆ has n≈1.35 and K₂SiF₆ has n≈1.34. The refractive index of nano-porous films or aero-gels can be as low as 1.05-1.1. For n≈1.1 the gain in reflected flux is approximately 2.

A preferred embodiment of the electro-optical display device according to the invention is characterized in that, the electro-optical medium is an electro-phoretic medium. Preferably, the electro-optical medium and the scattering medium are combined in the electro-phoretic medium. Preferably, the electro-phoretic display device comprises a plurality of separate electro-phoretic sub-pixels. In that case, it is advantageous to form a sub-pixel as a so-called microcapsule, known to the person skilled in the art.

In an alternatively preferred embodiment of the electro-optical display device according to the invention, the electro-optical medium is an electro-chromic medium. In a further preferred embodiment of the electro-optical display device according to the invention, the switching electrode and the electro-chromic medium are combined.

In a first embodiment of the electro-optical display device according to the invention, the low-refractive index material is provided between the electro-optical medium and the switching electrode associated with the front wall. By introducing a low refractive index layer directly above the scattering medium, light scattered at higher angles is first diffracted towards the normal on entering the front wall, and emerges more efficiently from the front wall. More scattered light will be emitted by the pixel and the electro-optical display device will appear brighter.

In a alternative embodiment of the electro-optical display device according to the invention, the low-refractive index material is provided between the translucent front wall and the switching electrode associated with the front wall. In this embodiment, the switching electrode is directly in contact with the electro-optical medium. This has the advantage that the voltage is applied directly to the electro-optical system and does not drop across the layer of the low-refractive index medium. In this embodiment the drive voltages are reduced. In addition, a substantial reduction of the image retention is achieved in the electro-optical display devices. This embodiment is particularly effective when the thickness of the switching electrode is less than or equal to the wavelength of the light (otherwise this will refract the scattered light and result in TIR). Normally, the thickness of the (ITO) switching electrodes in electro-optical display devices is much less than the wavelength of visible light.

In embodiments where the electro-phoretic medium in which the particles are immersed is a low-index material, the brightness enhancement will always be present and the brightness of the electro-optical display device increases substantially. The enhancement of the brightness is largest if the particles are situated close to the low-refractive index layer. In a further preferred embodiment, the particles produce scattering (scattering medium) close to the surface (i.e. small sized and highly scattering particles). The scattering works best when the pixel is at its maximum brightness (i.e. when all the white particles are close to the front wall): pixels at intermediate grey levels (where the white particles may be further from the surface) show less brightness enhancement.

In a third embodiment of the electro-optical display device according to the invention, the electro-optical medium comprises particles, the particles being provided in the low-refractive index material. By introducing the particles directly into a low refractive index liquid, light scattered at higher angles is diffracted towards the normal before entering the front wall, and emerges more efficiently from the front wall. More scattered light will be emitted by the pixel and the electro-optical display device will appear brighter.

Preferably, the distance between the low-refractive index material and the electro-optical medium is less than or equal to the wavelength of visible light. In an alternatively preferred embodiment of the electro-optical display device, the distance between the low-refractive index material and the electro-optical medium is less than or equal to 500 nm. In both embodiments, total internal reflection (TIR) can be effectively reduced.

These and other aspects of the invention are apparent from and will be elucidated with reference to the embodiments described hereinafter.

In the drawings:

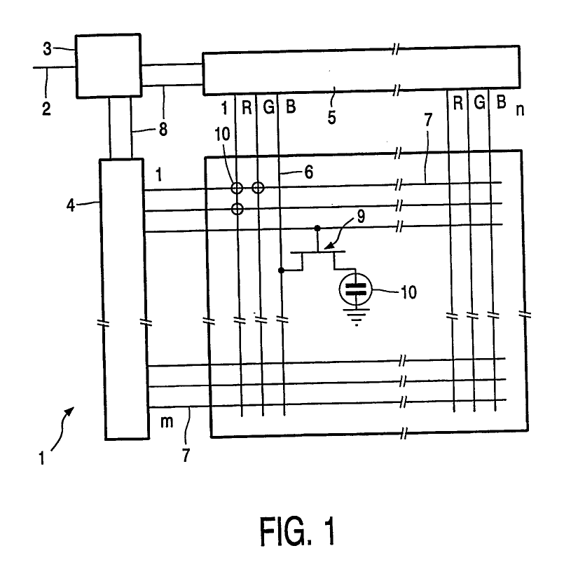

FIG. 1 shows an electro-optical display device,

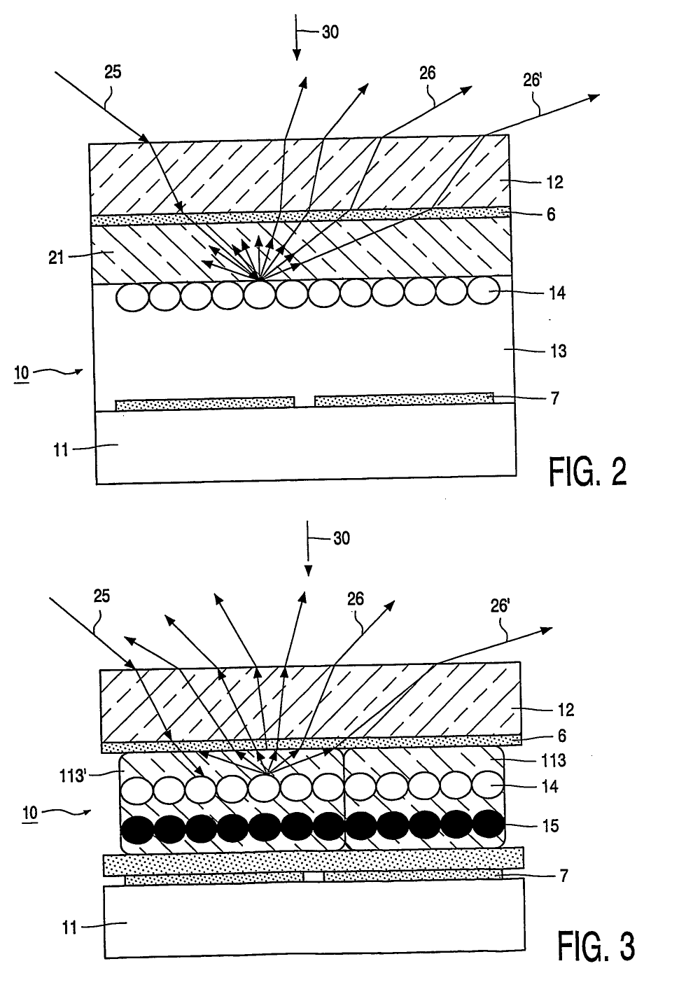

FIG. 2 shows a pixel of an electro-optical display device according to an embodiment of the invention in cross-section, and

FIG. 3 shows a pixel of an electro-optical display device according to an alternative embodiment of the invention in cross-section.

The Figures are purely diagrammatic and not drawn to scale. Particularly for clarity, some dimensions are exaggerated strongly. Similar components in the Figures are denoted by the same reference numerals as much as possible.

FIG. 1 shows very schematically an electric equivalent of a part of a electro-optical display device 1 to which the invention is applicable. It comprises a matrix of pixels 10 at the area of crossings of row or selection electrodes 7 and column or data electrodes 6. The row electrodes numbered from 1 to m in FIG. 1 are consecutively selected by means of a row driver 4, while the column electrodes numbered from 1 to n in FIG. 1 are provided with data via a data register 5. To this end, incoming data 2 are first processed, if necessary, in a processor 3. Mutual synchronization between the row driver 4 and the data register 5 takes place via drive lines 8 connected to the processor 3.

Drive signals from the row driver 4 and the data register 5 select a pixel 10 (referred to as passive drive). Normally, a column electrode 6 acquires such a voltage with respect to a row electrode 7 that the pixel assumes one of two extreme states at the area of the crossing (for example, black or colored, dependent on the colors of the liquid and the electro-optical particles).

If desired, drive signals from the row driver 4 may select the picture electrodes via thin-film transistors (TFTs) 9 whose gate electrodes are electrically connected to the row electrodes 7 and whose source electrodes are electrically connected to the column electrodes 6 (referred to as active drive). The signal at the column electrode 6 is transferred via the TFT to a picture electrode, coupled to the drain electrode, of a pixel 10. The other picture electrodes of the pixel 10 are connected to, for example, ground, for example, by means of one (or more) common counter electrode(s). In the example of FIG. 1, such a TFT 9 is shown diagrammatically for only one pixel 10.

FIG. 2 shows schematically a pixel 10 of an electro-optical display device according to an embodiment of the invention in cross-section. The pixel 10 comprises a translucent front wall 12 made, for example, of glass or of a synthetic material. A switching electrode 6, preferably made of indium tin oxide (ITO), is associated with the front wall 12, in the example of FIG. 2, the switching electrode 6 is provided on the front wall 12. In addition, the pixel 10 comprises a rear wall 11 provided with at least one further switching electrode 7. In the example of FIG. 2, the pixel 10 is filled with an electro-phoretic medium, for example, a dark suspension or liquid 13 containing, in this example positively charged, white particles 14. The switching electrodes 6, 7 are connected to the drive means (not shown in FIG. 2) in order to realize the different optical states of the pixel 10. Depending on the voltage between the switching electrodes 6, 7, the white particles 14 move, for example, towards the switching electrode 6 associated with the front wall 12 of the pixel 10. Viewed from the viewing direction 30, the pixel 10 now has the color of the liquid 13 (which is dark or black in this case). Changing the voltage between the switching electrodes 6, 7, the white particles 14 move, for example, towards the further switching electrode 7 associated with the rear wall 12 of the pixel 10. Viewed from the viewing direction 30, the pixel 10 now has the color of the particle 14 (which is white in this case). The latter situation is exemplified in FIG. 2.

According to the measure of the invention, the pixel 10 comprises a low-refractive index material with a refractive index nji in the range from 1.0≦nₗᵢ≦1.6. In the example of FIG. 2, a layer of a low-refractive index material 21 is provided between the electro-optical medium and the switching electrode 6 associated with the translucent front wall 12. In an alternative embodiment, the low-refractive index material is provided between the translucent front wall and the switching electrode associated with the translucent front wall. Preferably, the thickness of the switching electrode is less than or equal to the wavelength of the light.

By adding one or more layers of a material with low refractive index between the electro-optical medium and the front wall of the electro-optical display, the brightness of the electro-optical display device is improved. The closer the refractive index of the low-index medium matches that of air, the more brightness improvement is realised. Preferably, the refractive index of the layer of low-refractive index material 21 is nₗᵢ≦1.5, preferably nₗᵢ≦1.4. Materials in the desired range of refractive indices are available. Preferably, the low-refractive index material is selected from the group formed by a fluor-polymer, a low-dielectric inorganic film and a low-dielectric nano-porous film. For fluor-polymers the refractive index is approximately 1.3 whereas the refractive index of nano-porous films or aero-gels is approximately 1.1. Low-dielectric films are for instance found in fluorides such as LiF, which has n≈1.39 or MgF₂ which has n≈1.38. In addition, fluosilicates are known to have a low index of refraction, e.g. MgSiF₆ has n≈1.35 and K₂SiF₆ has n≈1.34. The refractive index of nano-porous films or aero-gels can be as low as 1.05-1.1.

FIG. 2 shows a number of light rays (the arrows indicate the travelling direction). An incoming light ray 25 enters the front wall 12 from the air side of the pixel 10 and after passing the front wall 12 and the low-refractive index material 21, the light is diffusively scattered on one of the particles 14 (scattering medium) in the electro-phoretic liquid 13. By introducing (the layer of) the low refractive index material layer directly above the scattering particles 14 (scattering medium), light scattered at higher angles by the particles 14 is first diffracted towards the normal on entering the front wall 12 of the pixel. Substantially more light rays 26, 26′, . . . eventually emerge from the front wall 12, thereby enhancing the brightness of the pixel of the electro-optical display device. According to the measure of the invention an electro-optical display device is realized with a wide viewing angle and a high brightness.

To realize the highest gain in brightness, the distance between the low-refractive index material 21 and the electro-optical medium should preferably be less than or equal to the wavelength of visible light. Visible light encompasses the wavelength range in the electromagnetic spectrum from approximately 400 to 780 nm. Alternatively, the distance between the low-refractive index material (21) and the electro-optical medium is less than or equal to 500 nm.

FIG. 3 shows schematically a pixel 10 of an electro-optical display device according to an alternative embodiment of the invention in cross-section. Similar components have been given the same reference numeral. In the example of FIG. 3, the pixel 10 comprises a translucent front wall 12. A switching electrode 6 is provided on the front wall 12. In addition, the pixel 10 comprises a rear wall 11 provided with at least one further switching electrode 7. The pixel 10 is filled with a so-called encapsulated electro-optical medium 113, 113′, . . . In this example, each capsule 113, 113′, . . . comprises a scattering medium, for example, white particles 14 or black particles 15. The switching electrodes 6, 7 are connected to the drive means (not shown in FIG. 3) in order to realize the different optical states of the pixel 10. Depending on the voltage between the switching electrodes 6, 7, the white particles 14 move, for example, away from the switching electrode 6 associated with the front wall 12 while, at the same time, the black particle 15 move towards the switching electrode 6 associated with the front wall 12 of the pixel 10. Viewed from the viewing direction 30, the pixel 10 now has a black appearance. Changing the voltage between the switching electrodes 6, 7, the white particles 14 move, for example, towards the switching electrode 6 associated with the front wall 12 while, at the same time, the black particles 15 move away from the switching electrode 6 associated with the front wall 12 of the pixel 10. Viewed from the viewing direction 30, the pixel 10 now has a white appearance. The latter situation is exemplified in FIG. 3. According to this embodiment of the invention, the encapsulated electro-phoretic medium 113, 113′, . . . also comprises the low-refractive index liquid. Alternatively, the capsule walls are made of a low-refractive index material. In a further alternative embodiment, the low refractive index material is provided between the capsules and the switching electrode associated with the front wall of the pixel.

Preferably, the electro-optical display device comprises a plurality of separate electro-phoretic sub-pixels. In that case, it is advantageous to form a sub-pixel as a so-called microcapsule, known to the person skilled in the art. Such microcapsules may also be obtained by creating barriers, for example, polymer walls. By way of example so-called axially symmetric aligned micro-cells may be employed.

FIG. 3 shows a number of light rays (the arrows indicate the travelling direction). An incoming light ray 25 enters the front wall 12 from the air side of the pixel 10 and after passing the front wall 12, the light is diffusively scattered on one of the particles 14 in the encapsulated electro-phoretic medium. By combining the low refractive index material and the electro-phoretic medium, light scattered at higher angles by the particles 14 (scattering medium) is first diffracted towards the normal before entering the front wall 12 of the pixel. Substantially more light rays 26, 26′, . . . eventually emerge from the front wall 12, thereby enhancing the brightness of the pixel of the electro-phoretic display device. Accordingly, an electro-optical display device is realized with a wide viewing angle and a high brightness.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electro-optical display device comprising
a translucent front wall (12) and
at least one pixel (10) with an electro-optical medium, a scattering medium and a switching electrode (6) associated with the front wall (12), and drive means via which the pixel (10) can be brought to different optical states,
characterized in that
the pixel (10) comprises a low-refractive index material (21) with a refractive index nₗᵢ in the range from 1.0≦nₗᵢ≦1.6.

2. An electro-optical display device as claimed in claim 1, characterized in that the refractive index of the low-refractive index material (21) is nₗᵢ≦1.4.

3. An electro-optical display device as claimed in claim 1, characterized in that the low-refractive index material (21) is selected from the group formed by a fluor-polymer, a low-dielectric inorganic film and a low-dielectric nano-porous film.

4. An electro-optical display device as claimed in claim 1, characterized in that the low-refractive index material (21) is provided between the switching electrode (6) and the electro-optical medium.

5. An electro-optical display device as claimed in claim 1, characterized in that the low-refractive index material (21) is provided between the switching electrode (6) and the translucent front wall (12).

6. An electro-optical display device as claimed in claim 5, characterized in that the thickness of the switching electrode (6) is less than or equal to the wavelength of visible light.

7. An electro-optical display device as claimed in claim 1, characterized in that the electro-optical medium comprises particles (14; 15) of the low-refractive index material.

8. An electro-optical display device as claimed in claim 1, characterized in that the distance between the low-refractive index material (21) and the electro-optical medium is less than or equal to the wavelength of visible light.

9. An electro-optical display device as claimed in claim 1, characterized in that the distance between the low-refractive index material (21) and the electro-optical medium is less than or equal to 500 nm.

10. An electro-optical display device as claimed in claim 1, characterized in that the electro-optical medium is an electro-phoretic medium.

11. An electro-optical display device as claimed in claim 1, characterized in that the electro-optical medium and the scattering medium are combined as an electro-phoretic medium.

12. An electro-phoretic color display device as claimed in claim 1, characterized in that the electro-phoretic medium is present in a microcapsule.

13. An electro-phoretic color display device as claimed in claim 12, with one microcapsule per pixel or with one microcapsule per sub-pixel.

14. An electro-optical display device as claimed in claim 1, characterized in that the electro-optical medium is an electro-chromic medium.

15. An electro-optical display device as claimed in claim 14, characterized in that the switching electrode and the electro-chromic medium are combined.
